(19) United States
(12) Patent Application Publication
(10) Pub. No.: US 2009/0047560 A1
(43) Pub. Date: Feb. 19, 2009

(54) FUEL CELL

(76) Inventors: Nobuyasu Negishi, Tokyo (JP); Hiroyuki Hasebe, Tokyo (JP); Yuichi Yoshida, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/067,189

(22) PCT Filed: Sep. 14, 2006
(86) PCT No.: PCT/JP2006/318256

§ 371 Date: Mar. 18, 2008

(30) Foreign Application Priority Data
Sep. 20, 2005 (JP) 2005-272543

(51) Int. Cl. H01M 8/10

(52) U.S. Cl. 429/30

(57) ABSTRACT

The invention relates to a fuel cell including a plurality of catalyst layer electrodes disposed as each catalyst layer electrode of an anode and a cathode in parallel on substantially the same plane and each having a shape with a specified aspect ratio, a liquid fuel impregnation layer laminated on the liquid fuel receiving chamber side of a vapor-liquid separating membrane, and a liquid fuel supply frame laminated on the liquid fuel receiving chamber side of the liquid fuel impregnation layer and formed with single or a plurality of fuel supply ports which supply the liquid fuel to the liquid fuel impregnation layer that is formed at the position corresponding to substantially the same position of the anode catalyst layer electrode.

### CROSS REFERENCE TO RELATED APPLICATIONS

This is a Continuation Application of PCT Application No. PCT/JP2006/318256, filed Sep. 14, 2006, which was published under PCT Article 21(2) in Japanese.

This application is based upon and claims the benefit of priority from prior Japanese Patent Application No. 2005-272543, filed Sep. 20, 2005, the entire contents of which are incorporated herein by reference.

### BACKGROUND OF THE INVENTION

1. Field of the Invention

The present invention relates to a horizontally arranged fuel cell effective for the action of portable devices.

2. Description of the Related Art

In these years, various electronic devices such as personal computers and portable telephones have been miniaturized along with the development of semiconductor technologies and an attempt has been made to use a fuel cell in these small-sized devices.

Fuel cells have the advantage that they generate electricity only by supplying fuel and an oxidizer and can generate electricity continuously only by exchanging fuel. Therefore, they are very advantageous systems to operate portable electronic devices if they can be miniaturized. Particularly, direct methanol fuel cells (DMFCs) use methanol having a high energy density as fuel and can draw current directly from methanol on an electrode catalyst. These cells, therefore, can be miniaturized. Also, handling of fuel is easier than that of hydrogen gas fuel and therefore, DMFCs are desirable as power sources for small devices and are expected to be put into practical use as the most suitable power sources for cordless portable devices such as notebook personal computers, portable telephones, portable audio players and portable game consoles.

As to a method of supplying fuel for DMFCs, gas-supply-type DMFCs in which after liquid fuel is gasified, the gasified fuel is fed to a fuel cell by a blower, liquid-supply-type DMFCs in which liquid fuel is fed, as it is, to a fuel cell by a pump, and internal-gasifying-type DMFCs in which liquid fuel is gasified in a cell are known.

Patent Documents 1 to 5 each disclose a fuel cell which is provided with a single unit cell or plural unit cells covered with a protective cover and a liquid fuel tank disposed around the unit cells, wherein the unit cell is a membrane electrode assembly (MEA) formed from an anode provided with a solid electrolyte membrane having proton conductivity, a catalyst layer electrode having carbon microparticles carrying a catalyst coated with an ion exchange resin and a gas diffusing layer that supplies reaction fuel to the catalyst layer electrode and collects charges, the anode generating charges and protons from the fuel and water, and a cathode provided with a catalyst layer electrode having carbon microparticles carrying a catalyst coated with an ion exchange resin and a gas diffusing layer that supplies oxygen to the catalyst layer electrode and conducts charges, the cathode generating water from proton and oxygen.

Patent Document 1: Jpn. Pat Appln. KOKAI Publication No. 2003-317791

Patent Document 2: Jpn. Pat Appln. KOKAI Publication No. 2004-014148

Patent Document 3: Jpn. Pat Appln. KOKAI Publication No. 2002-015763

Patent Document 4: Jpn. Pat Appln. KOKAI Publication No. 2004-235084

Patent Document 5: Jpn. Pat Appln. KOKAI Publication No. 2004-103262

### BRIEF SUMMARY OF THE INVENTION

However, the working voltage of a DMFC per unit cell is as low as about 0.3 to 0.5 and it is therefore necessary to arrange plural unit cells in series to be incorporated into a device. When these unit cells are incorporated into, particularly, small-sized portable devices such as notebook personal computers, portable telephones, portable audio players and portable game consoles, it is necessary to arrange plural unit cells in series on the same plane. Also, in a DMFC, current can be substantially drawn by supplying fuel to the anode side and it is therefore necessary to supply fuel to the unit cells as uniformly as possible when current load is applied.

However, in the so-called passive-type DMFC having no auxiliary machine such as a pump, fuel is supplied by natural supply system utilizing a capillary phenomenon and gravitational force and there is a fear that the fuel supply balance is upset depending on the working condition of equipment. This brings about ununiform existing amount and concentration of fuel, which generates a variation in voltage between cells, causing polarity inversion.

When the liquid fuel is supplied to the vapor-liquid separating membrane from a fuel supply port 114 formed at the position corresponding to the position of the unit cell of a fuel cell 100 as shown in FIG. 5 in, for example, an air-supply-type fuel cell provided with a liquid fuel receiving chamber that receives liquid fuel and a vapor-liquid separating membrane that supplies a vapor component of the liquid fuel to an anode, the anode catalyst layer electrodes 112 (E1 to E6) are brought into contact with the vaporized liquid fuel in order from a position where electrodes on the left and on the center side are adjacent to each other to generate electricity. However, during time until the fuel is sufficiently spread over the entire cell, the anode catalyst layer electrodes E3 to E6 on the right side in the figure do not start generating electricity or generate only a small amount of electricity, and therefore the generating actions are varied according to a difference in relative distance from the position of the fuel supply port 114 to each of the catalyst layer electrodes E1 to E6.

Also, when the fuel cell 100 is made to restart operating after it is once suspended, the residual amounts of the fuel left in anode catalyst layer electrodes E1 to E6 are different from each other and there is, therefore, a difference in the rise of generating action of each cell, so that a desired generating performance cannot be obtained.

The present invention has been made to solve the above problem and it is an object of the present invention to provide a fuel cell that is free from a variation in generating action between cells but has a good generating performance.

A fuel cell provided with a plurality of unit cells connected in series and provided with an electrolytic film, an anode and a cathode arranged so as to face each other with the electrolytic film interposed therebetween, a liquid fuel receiving chamber which is disposed on the anode side of said plurality of unit cells to receive liquid fuel, and a vapor-liquid separating membrane disposed between the anode and the liquid fuel receiving chamber to supply a gasified component of the liquid fuel to the anode, the fuel cell comprising:

a plurality of catalyst layer electrodes disposed as each catalyst layer electrode of the anode and cathode in parallel on substantially the same plane and each having a shape with a specified aspect ratio;

a liquid fuel impregnation layer laminated on the liquid fuel receiving chamber side of the vapor-liquid separating membrane; and

a liquid fuel supply frame laminated on the liquid fuel receiving chamber side of the liquid fuel impregnation layer and formed with single or a plurality of fuel supply ports which supply the liquid fuel to the liquid fuel impregnation layer that is formed at the position corresponding to substantially the same position of the anode catalyst layer electrode.

In this case, the fuel cell is preferably a stationary-type in which one end of the longitudinal direction of the catalyst layer electrode is placed at a position relatively higher than the other end, the fuel supply port is disposed in the liquid fuel supply frame at the position corresponding to and adjacent to one end of the longitudinal direction of the catalyst layer electrode, and the relative positional relation between the fuel supply port and the catalyst layer electrode is not substantially changed at the time of power generation. In a passive-type fuel cell, not only a capillary phenomenon but also gravitation force is utilized for supplying fuel and therefore, there is a fear that the postures of the devices mounted on the fuel cell at the time of power generation exert a serious influence on the generating performance. Therefore, in this invention, the MEA including the catalyst layer electrode is arranged so as to be inclined in the longitudinal direction of the electrode, so that one end of the longitudinal direction of the catalyst layer electrode is placed at a relatively higher position than the other end, the fuel supply port of the liquid fuel supply frame is disposed at a position adjacent to one end of the longitudinal direction of the catalyst layer electrode, and the liquid fuel is supplied to a liquid fuel impregnation layer laminated on the vapor-liquid separating membrane to thereby supply the fuel from the fuel supply port disposed at a higher position. As a result, the liquid fuel gasified from the vapor-liquid separating membrane can disperse the fuel smoothly and uniformly over the MEA including plural catalyst layer electrodes.

Also, plural catalyst layer electrodes are arranged side by side at specified intervals and are made to have the end parts arranged substantially in the same line along the long side. This structure defines the relation of the relative position of the catalyst layer electrode to the fuel supply port, bringing about uniformed fuel distribution. In the meantime, a number of voids constituted of fine pores formed between the secondary or tertiary particles of microparticles of carbon or the like are present in the catalyst layer electrode. These voids function as a reaction gas distribution passage in the catalyst layer electrode and it is desirable that the fuel be diffused over the entire catalyst layer electrode as uniformly as possible to obtain good power generating performance. Also, in order to suppress the variations in the amount of electricity to be generated between these cells, it is desired to form the fuel supply port of the liquid fuel supply frame at the position corresponding to each catalyst layer electrode and to supply the fuel uniformly to the position corresponding to each catalyst layer electrode from the liquid fuel impregnation layer.

Specifically, plural fuel supply ports corresponding to plural catalyst layer electrodes one by one may be disposed at a position corresponding to the vicinity of one end of each catalyst layer electrode (see 46A in FIG. 2), or one fuel supply port corresponding to plural catalyst layer electrodes may be disposed at a position corresponding to the vicinity of one end of each catalyst layer electrode (see 46C in FIG. 3). If each fuel supply port is disposed at the position corresponding to each catalyst layer, the fuel is supplied uniformly to each catalyst layer electrode.

Also, the fuel supply port may be disposed at the position corresponding to the vicinity of one end or the center of the longitudinal direction of the catalyst layer electrode (see 46B in FIG. 3). When the fuel supply port is disposed at the position corresponding to the vicinity of the center part of the longitudinal direction of the catalyst layer electrode, the time required until the fuel reaches the end of the longitudinal direction of the catalyst layer electrode is reduced.

Also, the fuel cell may be provided with plural fuel supply ports having substantially the same diameter and corresponding to plural catalyst layer electrodes one by one (see 46D in FIG. 4). If each fuel supply port is designed to have the same diameter, the fuel is uniformly supplied to each catalyst layer electrode.

Although in FIGS. 2 to 4, a structure including only the catalyst layer electrode and the liquid fuel supply port is described to clarify their positional relation, that is, it is described so that, at first sight, the liquid fuel supply port is formed in contact with the catalyst electrode, at least the vapor-liquid separating membrane and the liquid fuel impregnation layer are actually provided between the both as shown in FIG. 1.

The aspect ratio of the catalyst layer electrode within a two-dimensional plane visual field is preferably in the range of 1 to 16 and most preferably in the range of 3 to 8. This is because, if the aspect ratio is less than 1, the electrode has a laterally lengthy shape, so that mutual distance from the fuel supply port to the next fuel supply port is too increased, which is undesirable from the viewpoint of design and the battery body tends to be large-sized.

This is also because when the aspect ratio of the catalyst layer electrode exceeds 16, on the other hand, even if the fuel supply port is disposed in the center of the longitudinal direction of the electrode, a sufficient amount of the fuel is scarcely spread rapidly to both ends of the longitudinal direction of the electrode in a short time and therefore, the problem as to variations in the amount of electricity to be generated between unit cells is not solved, resulting in a reduction in total generating efficiency. In order to obtain particularly high generating efficiency, the aspect ratio of the catalyst layer electrode is designed to be in the range of 3 to 8.

As a peripheral wall material defining the fuel supply port, it is desirable to use a hard resin, such as polyether ketone (trade name: PEEK, manufactured by Victrex PLC), polyphenylene sulfide (PPS) or polytetrafluoroethylene (PTFE), which is resistant to swelling with the liquid fuel. However, metal materials having high corrosion resistance such as stainless steel or nickel metal may be used if it is provided with a coating having high corrosion resistance.

As the fuel, an aqueous methanol solution or pure methanol, aqueous ethanol solution or pure ethanol, dimethyl ether, formic acid, aqueous sodium borohydride solution, aqueous potassium borohydride solution, aqueous lithium borohydride solution, or the like may be used. Also, the fuel having various concentrations ranging from 100% to several percents may be used. At any rate, a liquid fuel suitable for the fuel cell is stored.

### BRIEF DESCRIPTION OF THE SEVERAL VIEWS OF THE DRAWING

FIG. 1 is a side sectional view typically showing the structure of a fuel cell.

FIG. 2 is a plan view showing the layout of an electrode of a fuel cell according to an embodiment of the present invention.

FIG. 3 is a plan view showing the layout of an electrode of a fuel cell according to another embodiment.

FIG. 4 is a plan view showing the layout of an electrode in still another embodiment.

FIG. 5 is a plan view showing the layout of an electrode in a conventional fuel cell.

FIG. 6 is a characteristic view showing variations in voltages of a fuel cell according to a first embodiment and a fuel cell obtained in a comparative example when the fuel cell starts operating and when the fuel cell is measured under a fixed voltage.

FIG. 7 is a characteristic view showing variations in voltages of a fuel cell according to a second embodiment and a fuel cell obtained in a comparative example when the fuel cell starts operating and when the fuel cell is measured under a fixed voltage.

### DETAILED DESCRIPTION OF THE INVENTION

Preferred embodiments of the present invention will be explained with reference to the accompanying drawings.

### First Embodiment

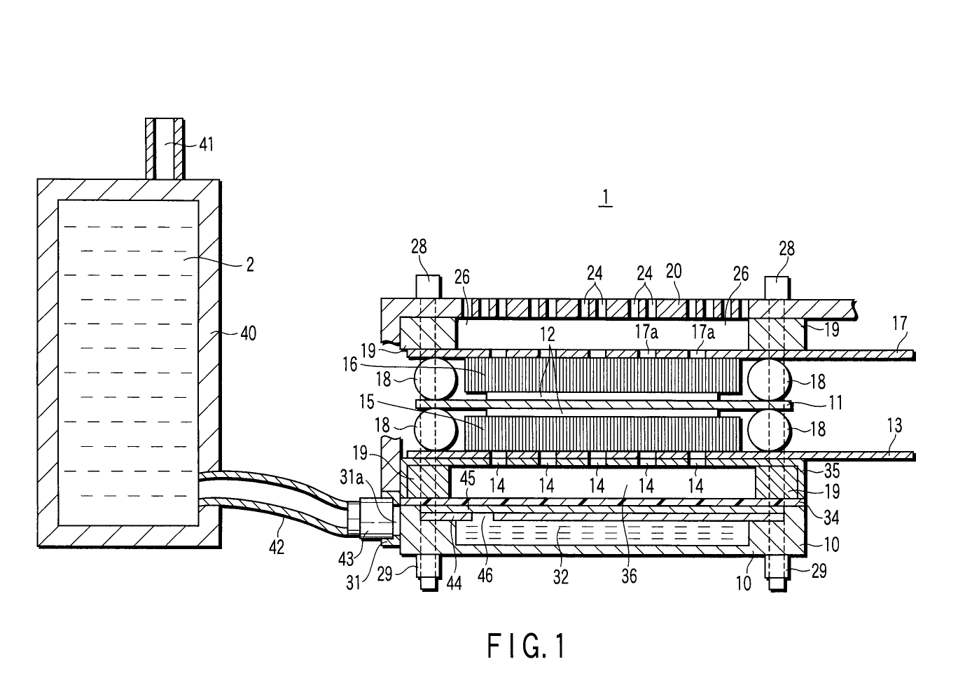

First, the whole outline of a fuel cell will be explained with reference to FIG. 1. A fuel cell 1 is wholly covered with a fuel tank 10, a protective cover 20 and the like and contains plural unit cells inside thereof. The fuel cell 1 is formed as one unit integrated in such a manner that the unit cells disposed inside thereof are fastened with a bolt 28 and a nut 29 from the side of the fuel tank 10 and protective cover 20 through a seal member 18. Various spaces and voids are formed by the seal member 18 as a press member and spacers 19 and 35 inside of the fuel cell 1. Among these spaces and voids, for example, spaces on the anode side are used as a liquid fuel receiving chamber 32 and a gasification chamber 36. A space on the cathode side is an air transmitting layer 26 and works to prevent micro-dusts and foreign matter from entering from the outside without inhibiting the transmission of the open air. As the air transmitting layer 26, a porous film having a porosity of 20 to 60% is preferably used.

In order to draw electrons into a negative electrode lead 13 from an anode gas diffusing layer 15 to make it possible to utilize the generated energy efficiently, the spacer 35 is fitted to the side opposite to the negative electrode lead 13 to define the gasification chamber 36. This gasification chamber 36 is disposed adjacent to the liquid fuel receiving chamber 32 and the both 32 and 36 are divided by the vapor-liquid separating membrane 34. The vapor-liquid separating member 34 is made of a polytetrafluoroethylene (PTFE) sheet having a number of pores and serves to cut the liquid fuel (methanol solution or its aqueous solution) and to transmit fuel gas (methanol gas).

Then, the fuel cell 1 is provided with a liquid fuel supply frame 44 formed with a liquid fuel impregnation layer 45 laminated on the liquid fuel receiving chamber 32 side of the vapor-liquid separating membrane 34 and with a fuel supply port 46 that supplies the liquid fuel to the liquid fuel impregnation layer 45 formed on the position corresponding to substantially the same part of the anode catalyst layer electrode 15.

An exhaust gas passage, though not shown, is provided on the anode side so as to discharge by-produced CO₂ gas out of the reaction system through the exhaust gas passage. Also, the negative electrode lead 13 is preferably provided with many openings and voids and has a shape that does not inhibit the diffusion of fuel component gas and by-produced gas (CO₂).

The liquid fuel receiving chamber 32 is constituted of a space having a fixed volume, the periphery of which is defined by the protective cover 10 and the liquid fuel supply frame 44, and a liquid introduction port 31a is opened in a proper position of the space (for example, the side surface of the fuel tank 10). For example, a bayonet-type coupler 31 (key-key way coupling joint) is fitted to the liquid introduction port 31a to close the fuel supply port 31a by the coupler 31 except for the time when the fuel is replenished. The coupler 31 on the fuel cell body side is made into such a form as to enable the outside cartridge side coupler 43 to engage therewith in a liquid-tight manner. When, for example, the coupler 43 on the outside cartridge side is guided while the groove of the coupler 43 is engaged with the projection of the coupler 31 on the fuel cell body side to push the coupler 43 into the coupler 31, a built-in valve of the coupler is opened to allow a cartridge side passage to communicate with a fuel cell body side passage, so that the liquid fuel 2 is allowed to flow into the liquid fuel receiving chamber 32 from a liquid introduction port 31a through a transport tube 42 by the internal pressure of the cartridge 40.

The periphery of the gasification chamber 36 is defined by the spacer 35 and the vapor-liquid separating membrane 34. The peripheral part of the spacer 35 is made into a U-shaped form in section so as to stand against the fastened force of the bolt and nut 28 and 29, thereby preventing the gasification chamber 36 from being deformed and a space having a prescribed width is secured as the gasification chamber 36.

Plural gasified fuel supply ports 14 are opened in the upper surface of the spacer 35. These gasified fuel supply ports 14 penetrate through the negative electrode lead 13 and are respectively communicated with the anode gas diffusing layer 15 side. When a part of the liquid fuel 2 in the liquid fuel receiving chamber 32 is gasified, the fuel gas component is introduced into the gasification chamber 34 through the vapor-liquid separating membrane 34 and further introduced into the anode gas diffusing layer 15 side from the gasification chamber 34 through the gasified fuel supply port 14 to thereby contribute to a power generating reaction.

The unit cell of the fuel cell is provided with the electrolytic film 11, an anode and a cathode. The anode and the cathode are disposed so as to face each other with the electrolytic film 11 interposed therebetween. The anode is provided with the anode catalyst layer electrode 12 and the anode gas diffusing layer 15. The anode catalyst layer electrode 12 serves to oxidize the fuel supplied through the gas diffusing layer 15 to draw electrons and protons from the fuel, and has a laminated structure in which the catalyst layer electrode 12 and the gas diffusing layer 15 are laminated. The anode catalyst layer electrode 12 is made of, for instance, a carbon powder containing a catalyst. As the catalyst, microparticles of platinum (Pt) or microparticles of transition metals such as iron (Fe), nickel (Ni), cobalt (Co), ruthenium (Ru) and molybdenum (Mo), or their oxides or alloys are used. In this case, if the catalyst is constituted of an alloy of ruthenium and platinum, this is preferable because the catalyst can be prevented from being deactivated by the adsorption of carbon monoxide (CO).

Also, the anode catalyst layer electrode 12 preferably contains microparticles of a resin used in the solid electrolytic film 11 which will be described later. This is for making it easy to transfer the generated protons. The anode gas diffusing layer 15 is constituted of a thin film made of, for example, a porous carbon material, and specifically, made of carbon paper, carbon fibers or the like. A negative electrode lead 13 conducted to the end of the anode gas diffusing layer 15 is extended externally.

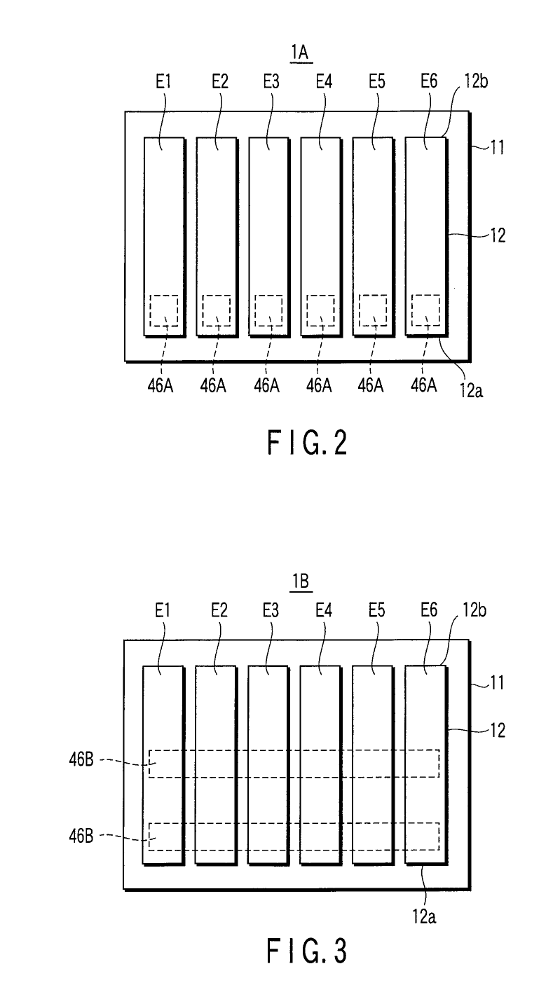

In this embodiment, as shown in FIG. 2, each of the fuel supply ports 46A of the liquid fuel supply frame 44 is opened at the position corresponding one by one to the vicinity of the end (short side) of the longitudinal direction of the anode gas diffusing layer 15 and its shape may be selected from those having a width larger than 60% of the length of the short side. The anode gas diffusing layer 15 has almost the same size as the anode catalyst layer electrode 12 and the both are closely stuck to and overlapped on each other over the entire surfaces by heat-press molding, with the result that the fuel supply ports 46 are respectively opened at the position corresponding one by one to the vicinity of the end (short side) of the longitudinal direction of the anode catalyst layer electrode 12. In this case, each anode catalyst layer electrode 12 has a narrow and long rectangular shape having an aspect ratio of 3 to 8 (aspect ratio in this embodiment: 6). Also, the interval between the neighboring anode catalyst layer electrodes 12 is about 1 mm. Also, the diameter of the fuel supply port 14 is about 2 to 5 mm. The shape of the fuel supply port 14 is not limited to a circular hole and may take various forms such as a long circle, ellipse, rectangle, triangle, pentagon or other polygons.

The cathode is provided with the cathode catalyst layer electrode 12 and the cathode gas diffusing layer 16. The cathode catalyst layer electrode 12 serves to reduce oxygen to react electrons with protons generated in the anode catalyst layer electrode 12, thereby producing water. The cathode catalyst layer electrode 12 and the cathode gas diffusing layer 16 have the same structures as, for example, the aforementioned anode catalyst layer electrode 12 and gas diffusing layer 15. Specifically, the cathode has a laminated structure in which the cathode catalyst layer electrode 12 made of a carbon powder containing a catalyst and the cathode gas diffusing layer 16 (gas transmission layer) made of a porous carbon material are laminated in this order from the solid electrolytic film 11 side. The catalyst used in the cathode catalyst layer electrode 12 is the same as that of the anode catalyst layer electrode 12 and there is also the case where the anode catalyst layer electrode 12 contains the microparticles of the resin to be used in the solid electrolytic film 11 like the case of the anode catalyst layer electrode 12. A positive electrode lead 17 conducted to the end of the cathode gas diffusing layer 16 is extended externally. Also, plural fine air holes 24 are formed in the protective cover 20 on the cathode side and are respectively communicated with the air transmission layer 26.

The electrolytic film 11 serves to transfer protons generated in the anode catalyst layer electrode 12 to the cathode catalyst layer electrode 12 and is made of a material that has no electron conductivity and can transfer protons. The electrolytic film 11 is constituted of, for example, a polyperfluorosulfonic-acid-type resin and specifically, Nafion film manufactured by Du Pont, Flemion film manufactured by Asahi Glass Company or Aciplex film manufactured by Asahi Chemical Industry Co., Ltd. Besides these polyperfluorosulfonic-acid-type resin films, an electrolytic film capable of transferring protons such as a copolymer film of a trifluorostyrene derivative, polybenzimidazole film impregnated with phosphoric acid, aromatic polyether ketone sulfonic acid film or aliphatic-hydrocarbon-type resin film may be used to constitute the electrolytic film 11.

The liquid fuel receiving chamber 32 having a liquid fuel storage space formed inside thereof is provided on the anode gas diffusing layer 15 on the side opposite to the electrolytic film 11. The use of liquid fuel having a high concentration has the advantage that the volumetric efficiency of the fuel cell is improved and also, the size and weight of a fuel cartridge carried together with the fuel cell are limited to each small level.

The protective cover 10 and the spacer 35 are preferably made of a hard plastic, such as poly-ether ether ketone (trade name: PEEK, manufactured by Victrex PLC), polyphenylene sulfide (PPS) or polytetrafluoroethylene (PTFE), which is resistant to swelling caused by liquid fuel. However, the protective cover 10 and the spacer 35 may be made of metal materials such as stainless steel and nickel metal if these metals are each coated with an anticorrosive material. When the fuel tank 10 and the spacer 35 are made of metal materials, it is necessary to interpose an insulating member (not shown) between the negative electrodes to prevent the negative electrodes disposed in the same battery container from developing short circuits.

There is the liquid fuel impregnation layer 45 laminated on the liquid fuel receiving chamber 32 side of the vapor-liquid separating membrane 34 in the liquid fuel receiving chamber 32. As the liquid fuel impregnation layer 45, for example, porous fibers such as a porous polyester fiber and porous-olefin-type resin, and continuous foam porous resin are preferable. This liquid fuel impregnation layer 45 is disposed between the vapor-liquid separating membrane 34 and the liquid fuel supply frame formed with the fuel supply port 46A, and the fuel is supplied homogeneously to the vapor-liquid separating membrane when the liquid fuel 2 in the fuel tank 10 is decreased or when the fuel cell body is mounted at a slope so that the supply of the fuel is unbalanced. As a result, the gasified liquid fuel can be homogeneously supplied to the anode catalyst layer 15. Besides the polyester fibers, various water-absorbing polymers such as acrylic-acid-type resin may be used to constitute the liquid fuel impregnation layer 45, and the liquid fuel impregnation layer 45 is constituted of a material, such as sponges or aggregates of fibers, which can retain a liquid by utilizing the penetrability of the liquid. This liquid fuel impregnation part is effective to supply a proper amount of fuel irrespective of the posture of the body. As the liquid fuel, an aqueous-organic-type solution containing hydrogen such as an aqueous methanol solution, pure methanol, aqueous ethanol solution, pure ethanol, aqueous propanol solution, aqueous formic acid solution, aqueous sodium formate solution, aqueous acetic acid solution, aqueous ethylene glycol solution and dimethyl ether are used. Among these, an aqueous methanol solution is preferable because it has a carbon number of 1, forms carbon dioxide gas in the reaction, enables a power generating reaction at low temperatures and can be produced relatively easily from industrial wastes. In any case, liquid fuel corresponding to a fuel cell is stored.

A number of air holes 24 that supply the open air by natural diffusion to the cathode gas diffusing layer 16 through, for example, clearances are opened in the protective cover 20 on the cathode side. These air holes 24 form openings through which the open air passes, wherein they respectively have a shape so devised that it can prevent fine and needle foreign substances from intruding into and being brought into contact with the cathode gas diffusion layer 16 from the outside without inhibiting the passage of the open air.

Since, in this embodiment, the fuel supply ports 46A are respectively opened at the position corresponding one by one to the vicinity of the end (short side) of the longitudinal direction of the anode catalyst layer electrode 12, the amount of the fuel to be supplied to each anode catalyst layer electrode 12 is equalized, which prevents a variation in the amount of electricity to be generated between the unit cells.

Specifically, by using a fuel cell evaluation cell shown in FIG. 1, six catalyst layer electrodes 12 (E1 to E6) having an aspect ratio of 1:5.8 were arranged in parallel on one electrolytic film 11, and a liquid fuel supply frame 44 in which the fuel supply ports 46A as shown in FIG. 2 were respectively opened at the position corresponding one by one to the end (short side) of the longitudinal direction of each anode catalyst layer electrode 12 was disposed. 10 ml of methanol having a purity of 99.9% by weight was supplied to the liquid fuel receiving chamber 32. Thereafter, each cell was subjected to measurements of the voltage at the start and 2.1V fixed voltage when generating electricity.

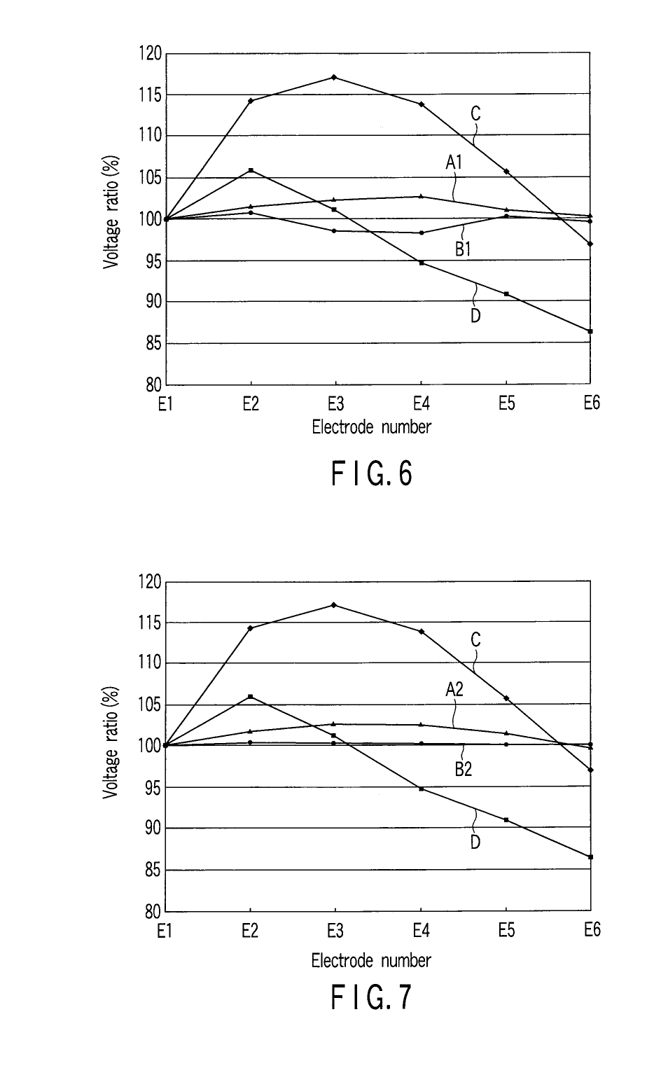

Also, for comparison, the same unit cell that was used in the above first embodiment was used and the liquid fuel supply port was disposed between the first and second anode catalyst layer electrodes 112 (E1 to E6) from the left end as shown by the liquid fuel supply port 114 in FIG. 5. Thereafter, each cell was subjected to measurements of the voltage at the start and 2.1V fixed voltage when generating electricity. As to the results of the measurement, the voltages of the cells corresponding to the anode catalyst layer electrodes E1 to E6 are shown in FIG. 6 as a voltage ratio (%) calculated when the voltage of the unit cell disposed on the left end was set to 100. In the figure, the characteristic line A1 shows the cell voltage characteristic at the start in Example 1, the characteristic B1 shows the cell voltage characteristic in the fixed voltage measurement (stationary power generation) in Example 1, the characteristic line C shows the cell voltage characteristic at the start in Comparative Example and the characteristic line D shows the cell voltage characteristic in the fixed voltage measurement (stationary power generation) in Comparative Example. As is clear from FIG. 6, in the fuel cell in the present embodiment, a variation in the voltage of each cell and a variation in the voltage at the start and during power generation can be limited to 2% or less and a variation in the amount of electricity to be generated between the unit cells is decreased. In the case of the fuel cell of Comparative Example, on the other hand, the voltage of the unit cell is reduced with an increase in distance from the liquid fuel supply port and the fuel cell fails to supply the fuel uniformly both at the start and in the power generation, leading to an increase in the variation of power generation between the unit cells.

### Second Embodiment

A second embodiment will be explained with reference to FIG. 3. To avoid duplication, explanations of the same parts as those in the first embodiments are omitted in this embodiment.

In this embodiment, fuel supply port 46B or 46C formed of a single slit is adopted as the fuel supply port of a fuel cell 1A. The fuel supply port 46B or 46C is opened in a direction almost perpendicular to the long side of the anode catalyst layer electrode 12. Specifically, the fuel supply port 46B or 46C is located at positions where the distance from the fuel supply port 46B or 46C to the anode catalyst layer electrode 12 is almost the same. The width of the fuel supply port 46B or 46C is preferably in the range of 0.5 to 10% and more preferably in the range of 1 to 5% of the length of the long side of the catalyst layer electrode.

The fuel supply port 46B or 46C may be opened (46C) in the vicinity of the one side end (one short side) of the longitudinal direction of the anode catalyst layer electrode 12 or may be opened (46B) in the center of the longitudinal direction of the anode catalyst layer electrode 12. In the latter case, the fuel supplied from the fuel supply port 46B flows toward both ends 12a and 12b of the longitudinal direction of the anode catalyst layer electrode 12 from the center of the longitudinal direction thereof. Therefore, the time required to diffuse the fuel is about one-half of that of the former case and it is therefore possible to diffuse the fuel rapidly over the entire body of the anode catalyst layer electrode 12.

Specifically, by using a fuel cell evaluation cell shown in FIG. 1, six catalyst layer electrodes 12 (E1 to E6) having an aspect ratio of 1:5.8 were arranged in parallel on the electrolytic film 11, and a liquid fuel supply frame 44 in which the slit-like fuel supply ports 46C as shown in FIG. 3 were opened at the position corresponding to the vicinity of the end (short side) of the longitudinal direction of the anode catalyst layer electrode 12 was disposed. 10 ml of methanol having a purity of 99.9% by weight was supplied to the liquid fuel receiving chamber 32. Thereafter, each cell was subjected to measurements of the voltage at the start and 2.1V fixed voltage when generating electricity.

As to the results of the measurement together with the results of the measurement of the fuel cell used in the first embodiment, the voltages of the cells are respectively shown in FIG. 7 as a voltage ratio (%) calculated when the voltage of the unit cell disposed on the left end was set to 100. In the figure, the characteristic line A2 shows the cell voltage characteristic at the start in Example 2, the characteristic line B2 shows the cell voltage characteristic in the fixed voltage measurement (stationary power generation) in Example 2, the characteristic line C shows the cell voltage characteristic at the start in Comparative Example and the characteristic line D shows the cell voltage characteristic in the fixed voltage measurement (stationary power generation) in Comparative Example. As is clear from FIG. 7, a variation in the voltage of each cell and a variation in the voltage at the start and during power generation can be limited to ±2% or less and a variation in the amount of electricity to be generated between the unit cells is decreased. In the case of the fuel cell of Comparative Example, on the other hand, the voltage of the unit cell is reduced with an increase in distance from the liquid fuel supply port and the fuel cell fails to supply the fuel uniformly both at the start and in the power generation, leading to an increase in the variation of power generation between the unit cells.

### Third Embodiment

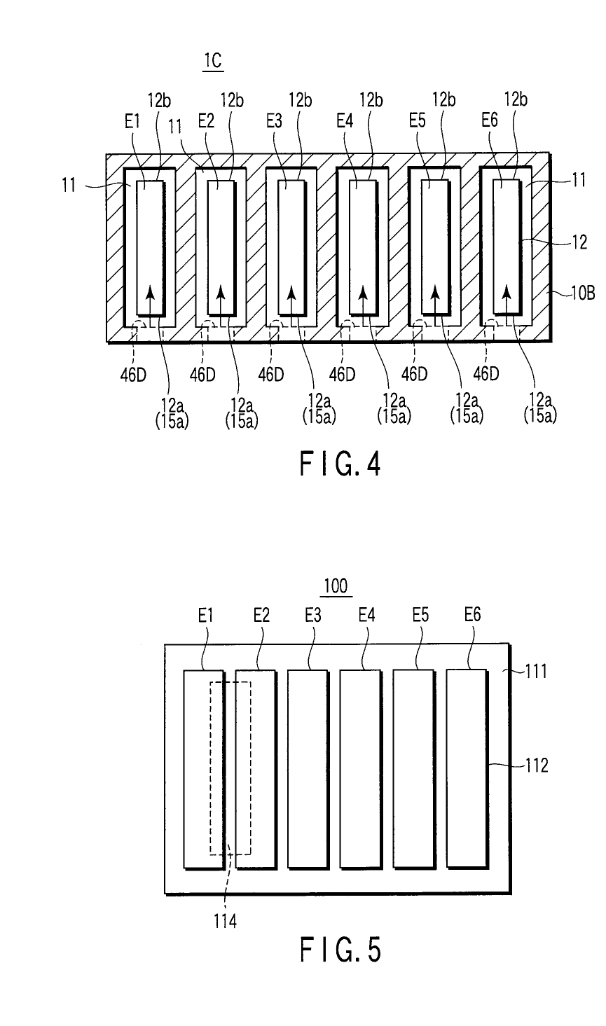

A third embodiment will be explained with reference to FIG. 4. To avoid duplication, explanations of the same parts as those in the first and second embodiments are omitted in this embodiment.

In this embodiment, a stationary type (for example, a notebook personal computer) substantially unchanged in its posture is used as the device into which a fuel cell 1B is incorporated. Specifically, in stationary-type devices, the relative positional relation between the fuel supply port 46D and the catalyst layer electrode 12 is not substantially changed. One end 12a of the longitudinal direction of the anode catalyst layer electrode 12 is located at a relatively higher position than the other end 12b and the fuel supply port 46D is respectively opened in the vicinity of one end (one short side) of the longitudinal direction of each of the plural anode catalyst layer electrodes E1 to E6 (12).

In a passive-type fuel cell, not only a capillary phenomenon but also gravitation force is utilized for supplying fuel and therefore, there is a fear that the postures of the devices mounted on the fuel cell in power generation exert a serious influence on the generating performance. Therefore, in this invention, the MEA including the catalyst layer electrodes E1 to E6 is arranged so as to be inclined in the longitudinal direction of the electrode to situate one end 12a of the longitudinal direction of the catalyst layer electrode at a relatively higher position than the other end 12b, and the fuel supply port 46D is disposed adjacent to one end 12a of the longitudinal direction of electrode to thereby supply the liquid fuel from the fuel supply port 46D disposed at a higher position. As a result, the fuel can be dispersed smoothly over the entire MEA including plural catalyst layer electrodes E1 to E6. This suppresses a variation in the amount of power generation between the unit cells at the start or at the restart.

The present invention has been explained based on various embodiments. However, the present invention is not limited to the above embodiments and various modifications and combinations are possible.

The present invention ensures a good battery performance and makes it possible to obtain output characteristics reduced in a variation as power sources of, for example, cordless portable devices such as notebook personal computers, portable telephones, portable audio players and portable game consoles.

What is claimed is:

1. A fuel cell provided with a plurality of unit cells connected in series and provided with an electrolytic film, an anode and a cathode arranged so as to face each other with the electrolytic film interposed therebetween, a liquid fuel receiving chamber which is disposed on the anode side of said plurality of unit cells to receive liquid fuel, and a vapor-liquid separating membrane disposed between the anode and the liquid fuel receiving chamber to supply a gasified component of the liquid fuel to the anode, the fuel cell comprising:
a plurality of catalyst layer electrodes disposed as each catalyst layer electrode of the anode and cathode in parallel on substantially the same plane and each having a shape with a specified aspect ratio;
a liquid fuel impregnation layer laminated on the liquid fuel receiving chamber side of the vapor-liquid separating membrane; and
a liquid fuel supply frame laminated on the liquid fuel receiving chamber side of the liquid fuel impregnation layer and formed with single or a plurality of fuel supply ports which supply the liquid fuel to the liquid fuel impregnation layer that is formed at the position corresponding to substantially the same position of the anode catalyst layer electrode.

2. The fuel cell according to claim 1, wherein the fuel cell is of a stationary type in which the catalyst layer electrode has a narrow and long shape having a specified aspect ratio, the one end of the longitudinal direction is located at a relatively higher position than the other end, the fuel supply port is disposed at the position corresponding to and adjacent to one end of the longitudinal direction of the catalyst layer electrode of the liquid fuel supply frame, and the relative positional relation between the fuel supply port and the catalyst layer electrode is not substantially changed at the time of power generation.

3. The fuel cell according to claim 1, wherein said plurality of catalyst layer electrodes are arranged side by side at specified intervals and have ends arranged in substantially the same line along the long side.

4. The fuel cell according to claim 1, wherein the fuel supply port of the liquid fuel supply frame is arranged at the position corresponding to and adjacent to one end of the longitudinal direction of the catalyst layer electrode.

5. The fuel cell according to claim 1, wherein the fuel supply port of the liquid fuel supply frame is arranged at the position corresponding to and adjacent to the center of the longitudinal direction of the catalyst layer electrode.

6. The fuel cell according to claim 1, wherein the liquid fuel supply frame is provided with a plurality of fuel supply ports having almost the same diameter and corresponding one by one to said plurality of catalyst layer electrodes.
